(19) United States
(12) Patent Application Publication
(10) Pub. No.: US 2018/0132131 A1
(43) Pub. Date: May 10, 2018

(54) CUSTOMIZED WIRELESS DATA CHUNKING

(71) Applicant: GENERAL MOTORS LLC, Detroit, MI (US)

(72) Inventors: George A. Mather, Shelby Township, MI (US); Shawn F. Granda, Novi, MI (US)

(21) Appl. No.: 15/344,264

(22) Filed: Nov. 4, 2016

(51) Int. Cl. H04W 28/06; H04W 28/02; H04L 29/08

(52) U.S. Cl. CPC H04W 28/06; H04L 67/12; H04W 28/0289

(57) ABSTRACT

A system and method of controlling the wireless transmission of data includes: determining one or more data chunk and quiescent period sizing factors selecting values for a data chunk size and a quiescent period for use in wirelessly transmitting data; transmitting a portion of a vehicle data package having the selected data chunk size from a remote facility to a vehicle; waiting for the quiescent period to pass; and transmitting another portion of the vehicle data package having the selected data chunk size after the quiescent period has passed.

### TECHNICAL FIELD

The present invention relates to wireless data transmissions and, more particularly to controlling the size and timing with which data chunks of data packages are wirelessly transmitted.

### BACKGROUND

Modern vehicles increasingly rely on software to operate different elements of vehicle hardware. The vehicle hardware frequently includes the capability to wirelessly communicate data with remotely-located facilities. The remotely-located facilities can wirelessly transmit data packages and other data to large numbers of vehicles. While wireless transmission of data to one vehicle may be relatively uncomplicated, wireless transmission of data to large numbers of vehicles may face a number of challenges. For instance, wirelessly transmitting a large number of data packages may strain the capability of a wireless carrier system to wirelessly transmit those data packages to the vehicles. It is possible to resolve or at least minimize these challenges by dynamically configuring the form in which the data package is sent based on data chunk size, timing of data chunk transmission, or both.

### SUMMARY

According to an embodiment of the invention, there is provided a method of controlling the wireless transmission of data. The method includes determining one or more data chunk and quiescent period sizing factors; selecting values for a data chunk size and a quiescent period for use in wirelessly transmitting data; transmitting a portion of a vehicle data package having the selected data chunk size from a remote facility to a vehicle; and waiting for the quiescent period to pass; and transmitting another portion of the vehicle data package having the selected data chunk size after the quiescent period has passed.

According to another embodiment of the invention, there is provided a method of controlling the wireless transmission of data. The method includes determining one or more data chunk size and quiescent period sizing factors; selecting values for a data chunk size value and a quiescent period for use in wirelessly transmitting data; transmitting a first portion of a vehicle data package having the selected data chunk size from a remote facility to a vehicle; waiting for the quiescent period to pass; transmitting a second portion of the vehicle data package having the selected data chunk size after the quiescent period has passed; determining updated data chunk size and quiescent period sizing factors; selecting an updated data chunk size value and an updated quiescent period value; and transmitting a third portion of the vehicle data package using the updated data chunk size and updated quiescent period value.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of controlling the wireless transmission of data.

### DETAILED DESCRIPTION OF THE ILLUSTRATED EMBODIMENT(S)

The system and method described below involves wirelessly transmitting data packages, such as vehicle software, to a plurality of vehicles. As part of transmitting the data packages to each vehicle, a remote facility can cleave or separate each data package into a plurality of individual data portions that comprise the data package. These individual data portions may be referred to here as “chunks” or “data chunks.” Generally speaking, data packages, such as vehicle software applications, are too large to send as a unitary item. So data packages each comprise a plurality of data chunks that can be sized in a way that facilitates wireless communication from a remote facility to a vehicle. To wirelessly transmit the data package from the remote facility to the vehicle(s), each chunk of the data package can be individually sent to the vehicle followed by a quiescent period that passes before another data chunk is sent. The amount of time needed for sending data packages to a large number of vehicles can be reduced by selectively controlling the size of each data chunk transmitted as well as the length of the quiescent period that passes before sending another data chunk of the data package.

Data chunk size and quiescent period length can be controlled based on one or more of a variety of factors. For example, chunk size and quiescent length can be controlled based on measured time to communicate data packages, the quantity of data packages to be sent, feedback from wireless carrier systems that send the data packages, the time of day, or the number of data packages that the remote facility failed to send, to name a few. These factors will be discussed below in more detail.

### Communications System—

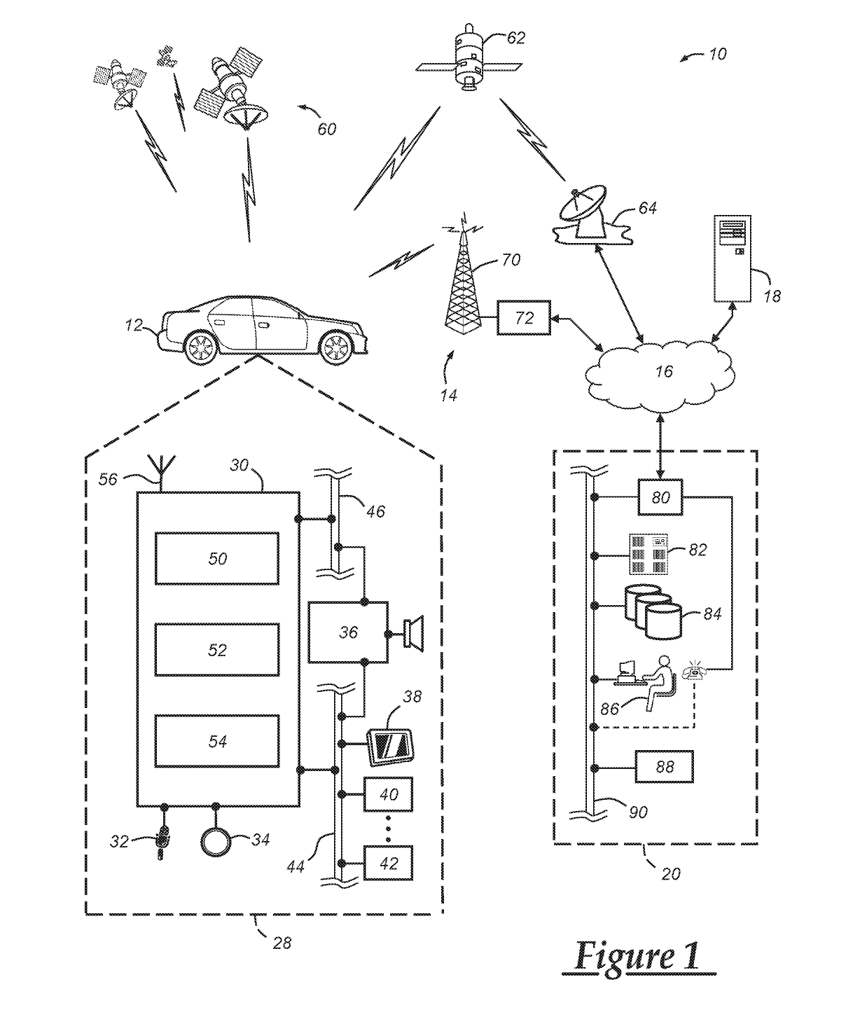

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

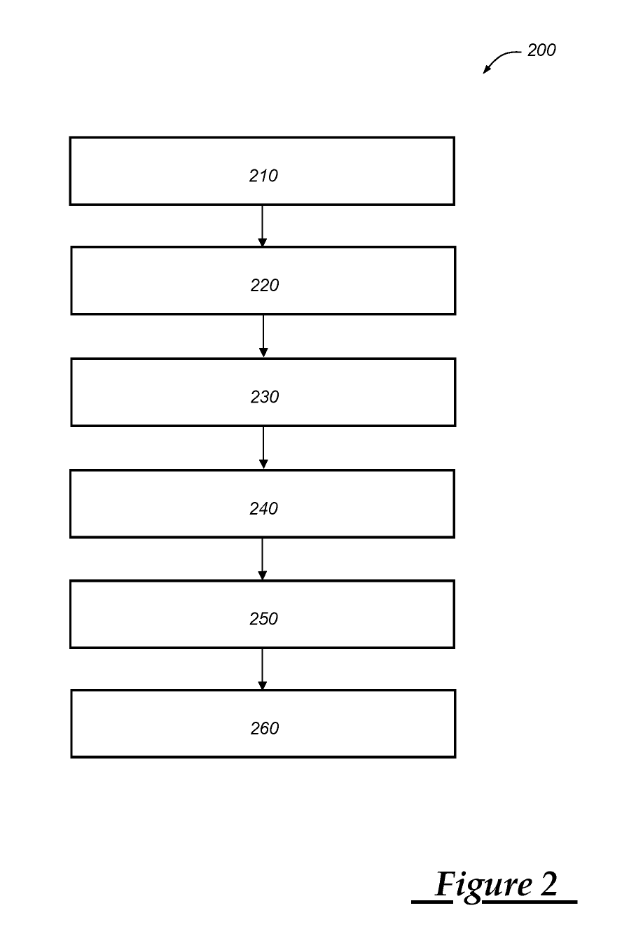

Turning now to FIG. 2, there is shown a method (200) of controlling the wireless transmission of data. The method 200 begins at step 210 by determining one or more data chunk size and quiescent period sizing factors. A remote facility sending data packages to a large number of vehicles may control the data chunk size of the data chunks comprising a data package. In this embodiment, the remote facility may send a data package in the form of a vehicle software application to a large number of vehicles. The remote facility may be implemented using the computer 18 or the call center 20; however, other types of remote facilities are possible. The data package can be transmitted to each vehicle, such as vehicle 12, as a plurality of data chunks that comprise the data package. When all of the data chunks have been received by vehicle 12 via its vehicle telematics unit 30, the vehicle 12 can combine the data chunks in a particular order to reassemble the data package. The vehicle 12 can then store the data package locally in the memory devices 54. After sending a data chunk, the remote facility can wait for a quiescent period to pass before sending another data chunk.

The data chunk size and the length of this quiescent period can be based on one or more factors. For example, the remote facility can determine the amount of time that passes between initially sending a first data chunk of a software package and a point when all of the data chunks have been successfully received by the vehicle 12. If the transmission of a data package between the remote facility and the vehicle 12 takes less time than expected, the remote facility can increase chunk size, decrease a quiescent period, or both for subsequently sent data packages. Conversely, if a data package takes more time to transmit than expected, chunk size could be decreased and or the quiescent period could be increased.

Other factors for determining the data chunk size and the length of this quiescent period can be considered by the remote facility. Notifications from the wireless carrier system 14 can be used to establish data chunk size and quiescent period length. If the wireless carrier system 14 transmits a data message to the remote facility indicating that its normal or ideal data transfer speeds have been reduced, the remote facility can decrease the data chunk size, increase the length of the quiescent period, or both to reduce demand on the wireless carrier system 14. This reduction in ideal data transfer speed can result from increased overall use of the wireless carrier system 14 by wireless devices, such as increased bandwidth used, or from a failure at some part of the system 14. The wireless carrier system 14 can also transmit a radio access technology (RAT) identifier to the remote facility, such as 3G v. LTE. More recent or sophisticated RATs like LTE can permit faster data transmissions than less recent or sophisticated RATs, such as 3G. The amount of vehicles the remote facility will wirelessly transmit data packages to can also be considered as a factor. If the remote facility plans to contact a large number of vehicles in a defined time period, data chunk size could be decreased, the quiescent period could be increased, or both.

The time of day is another factor that can be used to establish data chunk size and/or quiescent period length. Typically vehicles are driven during a period of time in the morning and a period of time in evening both of which coincide with rush hour. For example, these morning and evening time periods could be 6-9 AM and 4-7 PM. If a data package is transmitted to the vehicle 12 during these morning and evening time periods during which vehicles are typically driven involves reducing data chunk size and increasing the quiescent period length. On the other hand, one or more off-peak time periods can be established during which time data chunk size can be increased and quiescent period length decreased. For example, between midnight and 5 AM the remote facility might establish larger data chunk sizes, shorter quiescent periods, or both to maximize throughput. The method 200 proceeds to step 220.

At step 220, values of the data chunk size and quiescent period are selected for wirelessly transmitting data. The remote facility can use one or more of the factors discussed above to determine an appropriate data chunk size value and a quiescent period value. In one implementation, the data chunk size values can range from one megabyte (MB) to four thousand MB or four gigabytes (GB) while possible quiescent time periods can range from one second to 20,000 seconds. It is also possible to establish a default data chunk size value and a default quiescent period value. An example of these default values is 2 MB and 12,000 seconds (three hours and fifteen minutes). However, other default values are possible. When the remote facility receives information related to the factors described above, the remote facility can initially establish data chunk size values and quiescent period values. Or the remote facility can receive the information related to the factors described above and adjust the default values upwards or downwards based on that information.

In one example, the remote facility can attempt to wirelessly transmit vehicle software packages to 10,000 vehicles. This example will be described with reference to one of those vehicles—vehicle 12—but the steps for transmitting the software packages to the other vehicles are substantially the same. The remote facility can initially establish default values of 2 MB and 12,000 seconds for the data chunk size value and the quiescent period values, respectively. Before wirelessly transmitting the data packages, the remote facility can request and receive information relating to the factors that affect data chunk size and quiescent period. For example, the remote facility can contact the wireless carrier system 14 with a request to provide current data transfer speeds. The remote facility can also determine the time of day as well. In this example, the wireless carrier system 14 may be operating normally with no relative slowing of data transfer speeds and the time of day may be Monday at 5 PM. Using this information related to the factors, the remote facility can decide to reduce the default data chunk value and increase the quiescent period value to 1 MB and 18,000 seconds, respectively. It should be understood that this example is just one combination of a number of possible data chunk values and quiescent period values. Those skilled in the art will appreciate that a look up table can be stored in computer-readable memory at the remote facility providing possible combinations of data chunk values and quiescent period values (or adjustment of the default values) based on the information relating to the factors. The method 200 proceeds to step 230.

At step 230, a first portion of a data package having the selected data chunk size is transmitted from a remote facility to the vehicle 12. As part of sending data packages to each of the vehicles intended to receive those packages, the remote facility begins by initially sending a data chunk having the selected data chunk size. The following steps will be described with respect to the remote facility and the vehicle 12 but the data package transmission to other vehicles will be carried out in a similar way. The remote facility can identify contact information for the vehicle 12, such as a mobile dialed number (MDN), and place a call to the vehicle 12 using that information. When a valid data connection has been established with the vehicle 12 via the wireless carrier system 14, the remote facility can communicate the first portion or data chunk of the data package to the vehicle 12. After determining that the data chunk has been successfully sent by the remote facility, received by the vehicle 12, or both, the remote facility can initialize a timer for the length of the quiescent period. The method 200 proceeds to step 240.

At step 240, the remote facility waits for the quiescent period to pass and then transmits a second portion of the vehicle data package having the selected data chunk size after the quiescent period has passed. The remote facility can determine when the quiescent period has passed based on output from the timer. After the quiescent period has passed, in this example 18,000 seconds, the remote facility can wirelessly transmit a second data chunk having the selected data chunk size as described above with respect to step 230. The method 200 proceeds to step 250.

At step 250, updated data chunk size and quiescent period sizing factors are determined and updated data chunk size and quiescent period values are selected. As the remote facility wirelessly transmits data packages to the vehicles, the remote facility can reassess the data chunk size and the quiescent period values it selected. The factors used to select these values may have changed and new, updated data chunk size values and quiescent period values can be selected based on factors that have changed. For instance, continuing the example begun above, three hours may have passed since the remote facility began transmitting data packages making the time of day 8 PM on Monday. The remote facility can then access a lookup table and investigate whether the current time is now off-peak. If 8 PM is determined to be off-peak, the remote facility may choose to alter the previously-established default data chunk value and quiescent period value to 3 MB and 4,000 seconds, respectively. The method proceeds to step 260.

At step 260, a third portion of the vehicle data package is transmitted using the updated data chunk size and updated quiescent period value. The remote facility can then begin transmitting subsequent data chunks of 3 MB and waiting 4,000 seconds between transmitting subsequent data chunks. This can continue until all of the data chunks of the data package have been successfully transmitted to the vehicle 12 as well as other vehicles. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling the wireless transmission of data, comprising the steps of:
(a) determining one or more data chunk and quiescent period sizing factors;
(b) selecting values for a data chunk size and a quiescent period for use in wirelessly transmitting data;
(c) transmitting a portion of a vehicle data package having the selected data chunk size from a remote facility to a vehicle;
(d) waiting for the quiescent period to pass; and
(e) transmitting another portion of the vehicle data package having the selected data chunk size after the quiescent period has passed.

2. The method of claim 1, wherein at least one factor comprises the amount of time that passes between initially sending a first data chunk of a vehicle data package and a point when all of the data chunks of the vehicle data package have been successfully received by a vehicle.

3. The method of claim 1, wherein at least one factor comprises a notification received from a wireless carrier system.

4. The method of claim 3, wherein the notification includes a radio access technology (RAT).

5. The method of claim 1, wherein at least one factor comprises an amount of vehicles to whichi the remote facility wirelessly transmits data packages.

6. The method of claim 1, wherein at least one factor comprises a time of day.

7. The method of claim 1, wherein the data chunk size value is greater than or equal to one megabyte (MB) and less than or equal to four thousand MBs.

8. The method of claim 1, wherein the quiescent period value is greater than or equal to one second and less than or equal to 20,000 seconds.

9. The method of claim 1, further comprising the step of identifying a default data chunk size value and a default quiescent period value.

10. A method of controlling the wireless transmission of data, comprising the steps of:
(a) determining one or more data chunk size and quiescent period sizing factors;
(b) selecting values for a data chunk size value and a quiescent period for use in wirelessly transmitting data;
(c) transmitting a first portion of a vehicle data package having the selected data chunk size from a remote facility to a vehicle;
(d) waiting for the quiescent period to pass;
(e) transmitting a second portion of the vehicle data package having the selected data chunk size after the quiescent period has passed;
(f) determining updated data chunk size and quiescent period sizing factors;
(g) selecting an updated data chunk size value and an updated quiescent period value;
(h) transmitting a third portion of the vehicle data package using the updated data chunk size and updated quiescent period value.

11. The method of claim 10, wherein at least one factor comprises the amount of time that passes between initially sending a first data chunk of a vehicle data package and a point when all of the data chunks of the vehicle data package have been successfully received by a vehicle.

12. The method of claim 10, wherein at least one factor comprises a notification received from a wireless carrier system.

13. The method of claim 12, wherein the notification includes a radio access technology (RAT).

14. The method of claim 10, wherein at least one factor comprises an amount of vehicles to which the remote facility wirelessly transmits data packages.

15. The method of claim 10, wherein at least one factor comprises a time of day.

16. The method of claim 10, wherein the data chunk size value is greater than or equal to one megabyte (MB) and less than or equal to four thousand MBs.

17. The method of claim 10, wherein the quiescent period value is greater than or equal to one second and less than or equal to 20,000 seconds.
